(19) United States
(12) Patent Application Publication
(10) Pub. No.: US 2021/0356100 A1
(43) Pub. Date: Nov. 18, 2021

(54) Ground Insert lamp Installed Quickly

(71) Applicant: Dong Guan Jia Sheng Lighting Technology Co., Ltd. China, Dong-Guna City (CN)

(72) Inventor: Kevin Hsu, Taichung (TW)

(21) Appl. No.: 16/876,230

(22) Filed: May 18, 2020

(51) Int. Cl. F21V 17/12; F21V 21/08; F21V 21/10

(52) U.S. Cl. CPC F21V 17/12; F21V 21/10; F21V 21/0824

(57) ABSTRACT

A ground insert lamp includes a lighting device, a base, a connector, and a locking unit. The lighting device has a bottom provided with a screw hole. The base has a center provided with a mounting hole. The connector includes a restriction portion and a threaded rod mounted on the restriction portion. The lighting device and the connector are arranged at two sides of the base respectively. The threaded rod of the connector extends through the mounting hole of the base and is screwed into the screw hole of the lighting device. The locking unit is mounted on the base, and attaches the base to an installation position.

### BACKGROUND OF THE INVENTION

### 1. Field of the Invention

The present invention relates to an illuminating apparatus and, more particularly, to a ground insert lamp.

### 2. Description of the Related Art

A conventional ground insert lamp comprises a lamp body and a ground insert mounted on the bottom of the lamp body. The conventional ground insert lamp is mounted in the park, on the street or the like, by the ground insert. However, the conventional ground insert lamp is mounted outdoors only, and cannot be mounted indoors, such that the conventional ground insert lamp is not available for an installation position, such as a wall, a wood wall, a wall board or the like, thereby limiting the versatility thereof.

### BRIEF SUMMARY OF THE INVENTION

The primary objective of the present invention is to provide a ground insert lamp that is installed indoors and outdoors quickly.

In accordance with the present invention, there is provided a ground insert lamp comprising a lighting device, a base, a connector, and a locking unit. The lighting device has a bottom provided with a screw hole. The screw hole of the lighting device is provided with an internal thread. The base has a center provided with a mounting hole. The connector includes a restriction portion and a threaded rod mounted on a side of the restriction portion. The threaded rod of the connector is provided with an external thread. The lighting device and the connector are arranged at two sides of the base respectively. The threaded rod of the connector extends through the mounting hole of the base and is screwed into the screw hole of the lighting device. The locking unit is mounted on the base, and attaches the base to an installation position.

According to the primary advantage of the present invention, the connector locks the lighting device onto the base, and the locking unit locks the base onto the installation position, such that the ground insert lamp is installed easily and quickly.

According to another advantage of the present invention, the ground insert lamp is mounted indoors and outdoors, thereby enhancing the versatility of the ground insert lamp.

According to a further advantage of the present invention, the ground insert lamp is assembled and disassembled easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a ground insert lamp in accordance with the first preferred embodiment of the present invention.

FIG. 2 is a partial exploded perspective view of the ground insert lamp in accordance with the first preferred embodiment of the present invention.

FIG. 3 is a perspective view of a ground insert lamp in accordance with the second preferred embodiment of the present invention.

FIG. 4 is a partial exploded perspective view of the ground insert lamp in accordance with the second preferred embodiment of the present invention.

### DETAILED DESCRIPTION OF THE INVENTION

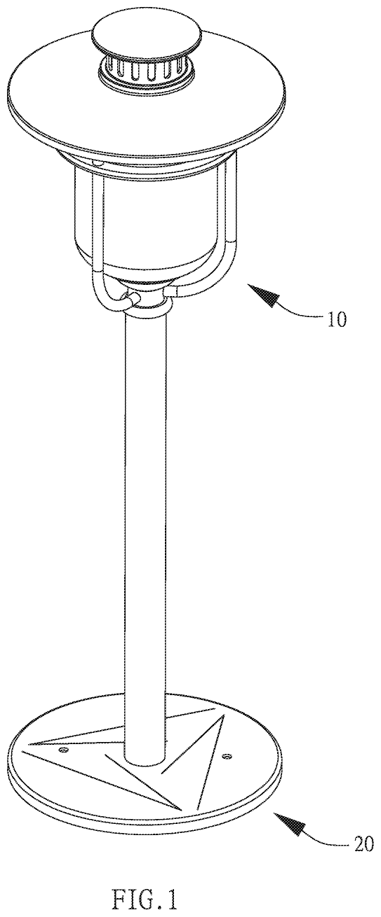

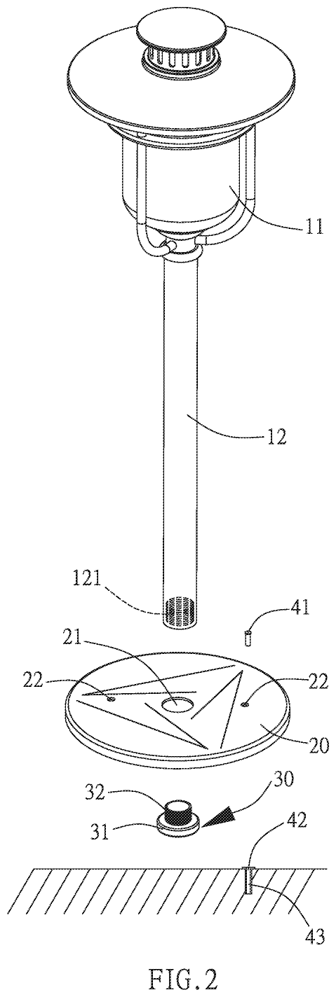

Referring to the drawings and initially to FIGS. 1 and 2, a ground insert lamp in accordance with the first preferred embodiment of the present invention comprises a lighting device 10, a base (or lamp disk) 20, a connector 30, and a locking unit.

The lighting device 10 has a bottom provided with a screw hole 121. The screw hole 121 of the lighting device 10 is provided with an internal thread. The base 20 has a center provided with a mounting hole 21. The mounting hole 21 of the base 20 penetrates a whole thickness of the base 20. The connector 30 includes a restriction portion 31 and a threaded rod 32 mounted on a side of the restriction portion 31. The threaded rod 32 of the connector 30 is provided with an external thread. The lighting device 10 and the connector 30 are arranged at two sides of the base 20 respectively, with the base 20 being located between the lighting device 10 and the connector 30. The threaded rod 32 of the connector 30 extends through the mounting hole 21 of the base 20 and is screwed into the screw hole 121 of the lighting device 10. The locking unit is mounted on the base 20, and attaches the base 20 to an installation position, such as a ground, a wall, a wood wall, a wall board or the like. Thus, the connector 30 locks the lighting device 10 onto the base 20, and the locking unit locks the base 20 onto the installation position.

In the first preferred embodiment of the present invention, the lighting device 10 includes a lamp body 11 and a shank 12 mounted on a bottom of the lamp body 11. The screw hole 121 of the lighting device 10 is formed in a bottom of the shank 12. The bottom of the shank 12 rests on the base 20 and has an outer diameter larger than an inner diameter of the mounting hole 21 of the base 20.

In the first preferred embodiment of the present invention, the base 20 is provided with a plurality of securing holes 22. The securing holes 22 of the base 20 surround the mounting hole 21. The locking unit includes a plurality of locking heads 42 and a plurality of screws 41. Each of the locking heads 42 is mounted on the installation position and is provided with a threaded hole 43. Each of the screws 41 extends through each of the securing holes 22 of the base 20 and is screwed into the threaded hole 43 of each of the locking heads 42.

In the first preferred embodiment of the present invention, each of the locking heads 42 is made of plastic material, and each of the screws 41 is made of wood material.

In the first preferred embodiment of the present invention, each of the locking heads 42 has a T-shaped configuration and has an enlarged top resting on the installation position.

In the first preferred embodiment of the present invention, the restriction portion 31 of the connector 30 has a dimension larger than that of the threaded rod 32 and that of the mounting hole 21 of the base 20. The threaded rod 32 of the connector 30 has an outer diameter equal to or slightly smaller than the inner diameter of the mounting hole 21 of the base 20.

In assembly, the shank 12 of the lighting device 10 and the connector 30 are arranged at two sides of the base 20 respectively. Then, the threaded rod 32 of the connector 30 extends through the mounting hole 21 of the base 20 and is screwed into the screw hole 121 of the shank 12. Thus, the connector 30 locks the lighting device 10 onto the base 20. Then, each of the locking heads 42 is affixed to the installation position. Then, each of the screws 41 extends through each of the securing holes 22 of the base 20 and is screwed into the threaded hole 43 of each of the locking heads 42. Thus, the locking unit locks the base 20 onto the installation position.

Accordingly, the connector 30 locks the lighting device 10 onto the base 20, and the locking unit locks the base 20 onto the installation position, such that the ground insert lamp is installed easily and quickly. In addition, the ground insert lamp is mounted indoors and outdoors, thereby enhancing the versatility of the ground insert lamp. Further, the ground insert lamp is assembled and disassembled easily and conveniently.

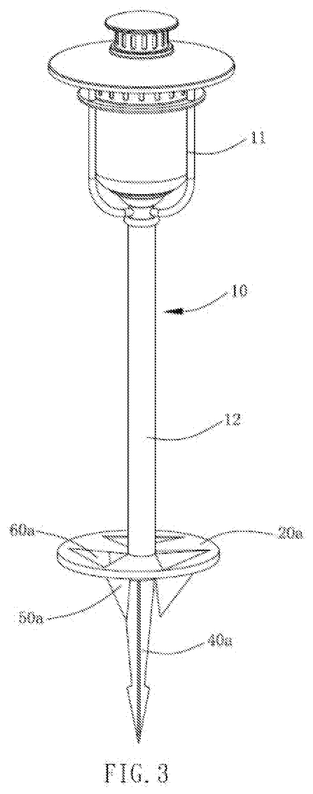

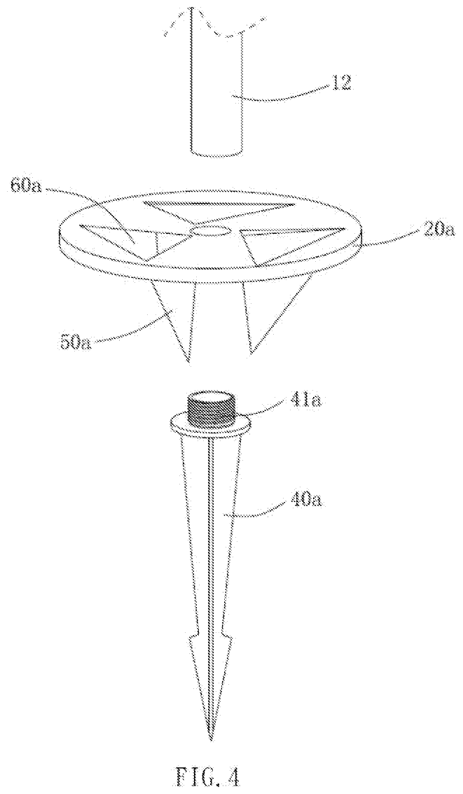

Referring to FIGS. 3 and 4, in accordance with the second preferred embodiment of the present invention, the locking unit includes a ground insert 40a, and the connector 41a is mounted on a top of the ground insert 40a. The connector 41a is provided with an external thread. Thus, the ground insert 40a is attached to the lighting device 10 by the connector 41a. Preferably, the ground insert 40a is attached to the shank 12 of the lighting device 10 by the connector 41a. Thus, the ground insert 40a extends downward from the base 20a.

In the second preferred embodiment of the present invention, the base 20a has a bottom provided with a plurality of blades 50a. The blades 50a of the base 20a surround the ground insert 40a. The blades 50a are perpendicular to the base 20a. Each of the blades 50a of the base 20a has a pointed shape and has a width tapering gradually from top to bottom. Thus, the blades 50a are inserted into the ground easily. In addition, the blades 50a increase the contact area of the ground insert 40a with the ground, such that the ground insert 40a is mounted steadily.

In the second preferred embodiment of the present invention, the ground insert 40a tapers gradually from top to bottom and has a cross-section with a cross-shaped configuration, such that the ground insert 40a is inserted into the ground steadily.

In the second preferred embodiment of the present invention, the base 20a is provided with a plurality of pry (or lever or tool) holes 60a allowing insertion of a lever or a tool. Thus, the ground insert 40a is easily removed from the ground by the pry holes 60a.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A ground insert lamp comprising:
a lighting device, a base, a connector, and a locking unit;
wherein:
the ground insert lamp is used indoors and outdoors;
the lighting device has a bottom provided with a screw hole;
the screw hole of the lighting device is provided with an internal thread;
the base has a center provided with a mounting hole;
the connector includes a restriction portion and a threaded rod mounted on a side of the restriction portion;
the threaded rod of the connector is provided with an external thread;
the lighting device and the connector are arranged at two sides of the base respectively;
the threaded rod of the connector extends through the mounting hole of the base and is screwed into the screw hole of the lighting device; and
the locking unit is mounted on the base, and attaches the base to an installation position.

2. The ground insert lamp as claimed in claim 1, wherein:
the lighting device includes a lamp body and a shank mounted on a bottom of the lamp body;
the screw hole of the lighting device is formed in a bottom of the shank and connected to the mounting hole of the base; and
the bottom of the shank directly rests on the base.

3. The ground insert lamp as claimed in claim 1, wherein:
the base is provided with a plurality of securing holes;
the securing holes of the base surround the mounting hole;
the locking unit includes a plurality of locking heads and a plurality of screws;
each of the locking heads is provided with a threaded hole; and
each of the screws extends through each of the securing holes of the base and is then screwed into the threaded hole of each of the locking heads to secure the base to the locking heads.

4. The ground insert lamp as claimed in claim 1, wherein:
the locking unit includes a ground insert;
the connector is secured to a top of the ground insert; and
the ground insert is attached to the lighting device by the connector.

5. The ground insert lamp as claimed in claim 4, wherein:
the base has a bottom provided with a plurality of blades directed downward;
the blades of the base surround the ground insert;
the blades are perpendicular to the base; and
each of the blades of the base has a pointed shape and has a width tapering gradually from top to bottom.

6. The ground insert lamp as claimed in claim 4, wherein the ground insert tapers gradually from top to bottom and has a cross-section with a cross-shaped configuration to increase a contact face of the ground insert.

7. The ground insert lamp as claimed in claim 4, wherein the base is provided with a plurality of pry holes directed upward and toward the lighting device.

8. The ground insert lamp as claimed in claim 1, wherein the connector has a cross-section with an inverted T-shaped configuration.

9. The ground insert lamp as claimed in claim 1, wherein the restriction portion and the threaded rod of the connector are formed integrally.

10. The ground insert lamp as claimed in claim 1, wherein the restriction portion of the connector has a diameter larger than that of the threaded rod.

11. The ground insert lamp as claimed in claim 1, wherein the restriction portion of the connector has a diameter larger than that of the mounting hole of the base.

12. The ground insert lamp as claimed in claim 2, wherein the base is sandwiched and limited between the bottom of the shank and the restriction portion of the connector.

13. The ground insert lamp as claimed in claim 2, wherein the bottom of the shank rests on one side of the base, and the restriction portion of the connector rests on the other side of the base.

14. The ground insert lamp as claimed in claim 3, wherein each of the securing holes extends through a whole thickness of the base.

15. The ground insert lamp as claimed in claim 3, wherein each of the locking heads has a cross-section with a T-shaped configuration.

16. The ground insert lamp as claimed in claim 3, wherein the base is sandwiched and limited between each of the screws and each of the locking heads.
